(19) United States
(12) Patent Application Publication
(10) Pub. No.: US 2002/0134180 A1
(43) Pub. Date: Sep. 26, 2002

(54) Automated disconnect mechanism with tension load limiter for linear actuator

(76) Inventors: Jacob Gorin, Studio City, CA (US); Steve Kim, Valencia, CA (US)

Correspondence Address: Menotti J. Lombardi, Esq., ITT Fluid Technology, 10 Mountainview Road, Upper Saddle River, NJ, 07458, US

(21) Appl. No.: 10/074,350

(22) Filed: Feb. 11, 2002

Related U.S. Application Data
(63) Continuation-in-part of application No. 09/414,227, filed on Oct. 7, 1999, now abandoned.

(51) Int. Cl. F16H 25/20

(52) U.S. Cl. 74/89.37; 74/89.38; 192/141

(57) ABSTRACT

A linear actuator for providing linear motion of an output shaft member and automatically disconnecting the shaft from a gear train comprising a rotatable shaft adapted to be coupled to an electrically powered gear train for causing rotation of the shaft; a shaft member mounted onto the rotatable shaft and axially moveable between a retracted position and an extended position in response to rotation of the shaft; a rotatable screw co-acting with the gear train to rotate in response to movement of the gear train; a second member mounted on the rotatable screw and axially moveable in response to rotation of the screw between the retracted position and the extended position; a switch unit located at at least one of the extended and retracted positions and responsive to engagement with the moveable second member for causing an electrical disconnection between the gear train and a power source to cause termination of shaft rotation; and a member coupled to the rotatable shaft for disconnecting the shaft from the gear train in response to the shaft member or second member reaching the retracted position.

### FIELD OF THE INVENTION

This invention relates generally to linear actuators, and more particularly to a linear actuator which automatically disconnects the output shaft assembly from the gear train at a predetermined position.

### BACKGROUND OF THE INVENTION

Linear actuators are used to provide linear motion in a variety of applications. The basic design of a linear actuator consists of an electrical motor, gear train and the output shaft assembly (together with the ball or threaded screw as the main component generating linear movement of the output shaft). Typically, at the ends of the output shaft linear travel there are limit switches which disconnect the electrical power in the motor and mechanical stops for preventing potential damage from the output shaft overtravel in case of a limit switch failure. If manual operation of an actuator is required, the output shaft assembly should be disconnected from the actuator gear train to allow free movement of the output shaft. This design capability is necessary in case of electric power failure, for maintenance and more important, in case of emergency and safety concerns, as for instance, a foreign object which becomes trapped during retraction.

Instead of the commonly used electromechanical (solenoid) clutch which requires continuous power consumption and generates heat, the apparatus according to the present invention disclosed herein automatically disconnects the output shaft assembly from the gear train at a full retracted position, when manual operation is mostly required; or if necessary, at full extended position. This design allows manual operation of the actuator without the use of an external cable and without electrical power. In addition, the apparatus according to the present invention provides for the incorporation of a device limiting the tension load exerted by the actuator along its entire stroke or at a specified location. As a result, the actuator will stop an operation when the tension load exceeds the preset threshold limit.

### SUMMARY OF THE INVENTION

A linear actuator for generating linear movement of a shaft member comprising an electrically powered gear train coupled to a shaft assembly disposed in a housing and including a rotatable member on which is mounted the shaft member for causing axial movement of the shaft member along an axis of the shaft assembly between a first extended position and a second retracted position; means responsive to the movement of the gear train for causing axial movement of a second member in proportion to the axial movement of the shaft member; disconnect means responsive to the axial position of the axially movable second member for automatically disconnecting power to the gear train when the second member reaches an at least one predetermined axial position to prohibit further axial movement of the shaft member; and decouple means for automatically decoupling the shaft assembly from the gear train according to at least one given axial position associated with the shaft member or the second member.

A linear actuator for providing linear movement of a shaft member and having automatic disconnect and tension load limiting characteristics comprising an electrically powered gear train coupled to a shaft assembly for causing movement of the shaft member and an associated axially movable second member along an axis between a first extended position and a second retracted position; bearing means responsive to a predetermined tension or compression force threshold level exerted on the actuator for automatically disconnecting electrical power between the gear train and a motor when the predetermined tension or compression force level is achieved, thereby prohibiting further automated movement of the shaft member; means for automatically decoupling the shaft assembly from the gear train when the second member reaches the at least one predetermined position along the axis.

A linear actuator for providing linear motion of an output shaft member and automatically disconnecting the shaft member from a gear train. The linear actuator comprises a rotatable shaft adapted to be coupled to an electrically powered gear train causing rotation of the shaft; a shaft member mounted onto the rotatable shaft and axially movable between a retracted position and an extended position in response to rotation of the shaft; rotatable screw co-acting with the gear train to rotate in response to movement of the gear train; a second member coupled to the rotatable screw and axially movable in response to rotation of the screw between a first axial position and a second axial position; switch means located at the first position and responsive to engagement with the movable second member for causing an electrical disconnection between the gear train and a power source to cause termination of shaft rotation; and means coupled to the rotatable shaft for disconnecting the shaft from the gear train in response to the shaft member reaching the retracted position or the second member reaching the second axial position.

A linear actuator for providing linear motion of a shaft member comprising a rotatable shaft on which the shaft member is mounted, the shaft adapted to be coupled to an electrically powered gear such that rotation of the gear causes rotation of the shaft and corresponding translation of the shaft member between a first extended position and a second retracted position along an axis of the shaft; disconnect means responsive to the position of the axially moving shaft member for automatically disconnecting power to the gear train when the shaft member reaches a predetermined position along the shaft axis; and decouple means for automatically disengaging the shaft from the gear when the shaft member reaches a given position on the shaft axis.

According to another aspect of the present invention, the decoupling mechanism includes an annular collar which surrounds a portion of the rotatable shaft and is coupled to an output gear. The collar has a first interior diameter bore, and a second larger interior diameter bore. A moveable bearing mechanism is located within the collar and moveable between the first interior diameter and the second interior diameter bores. When the bearing mechanism is positioned within the first diameter bore, the mechanism operates to frictionally engage axial grooves formed on the rotatable shaft to cause engagement with the gear train. When the bearing mechanism is displaced into the second larger diameter, this causes disengagement with the axial grooves on the rotatable shaft and permits movement of either one of the shaft assembly or the gear train without corresponding movement of the other. It is a further object of the present invention to provide an axially moveable sleeve member mounted on the rotatable shaft and moveable in response to a force resulting from the axially moveable second member or the shaft member when either the second member or the shaft member is located at the given position on the shaft associated with the shaft axis for moving a predetermined distance in a first direction to displace the bearing mechanism into the larger diameter interior surface of the collar, thereby causing decoupling of the shaft assembly from the gear train.

### BRIEF DESCRIPTION OF THE DRAWINGS

FIG. 1A is a schematic cross-sectional view of the linear actuator incorporating the automatic disconnect and tension load limiting features according to the present invention.

FIG. 1B is a schematic cross-sectional diagram illustrating the automatic disconnect and tension load limiter features shown in FIG. 1A in greater detail.

FIG. 1C is an exploded view of the ball screw rod end shown in FIG. 1B.

FIG. 1D is an exploded view of the output gear module of FIG. 1B.

FIG. 1E illustrates an exploded view of the sleeve portion of the linear actuator of shown in FIG. 1B.

FIG. 1F illustrates an exploded view of the cup portion of the linear actuator illustrated in FIG. 1B according to the present invention.

FIG. 1G illustrates a cross-sectional view taken along Section A-A of the linear actuator shown in FIG. 1B according to the present invention.

FIG. 2 illustrates a cross-sectional view of the linear actuator of the present invention in a retracted position.

FIG. 3 illustrates a cross-sectional view of the linear actuator of the present invention in an extended position.

FIG. 4 illustrates a cross-sectional view of an alternate embodiment of the linear actuator of the present invention in an extended position without disconnection of the ball screw.

FIG. 5 is a cross-sectional view of the linear actuator according to the present invention under a limited tension load.

FIG. 6 is a cross-sectional view of the linear actuator according to the present invention under tension load set specified positions.

FIG. 7 illustrates a view of the linear actuator manually disengaged via an external handle.

### DETAILED DESCRIPTION OF THE INVENTION

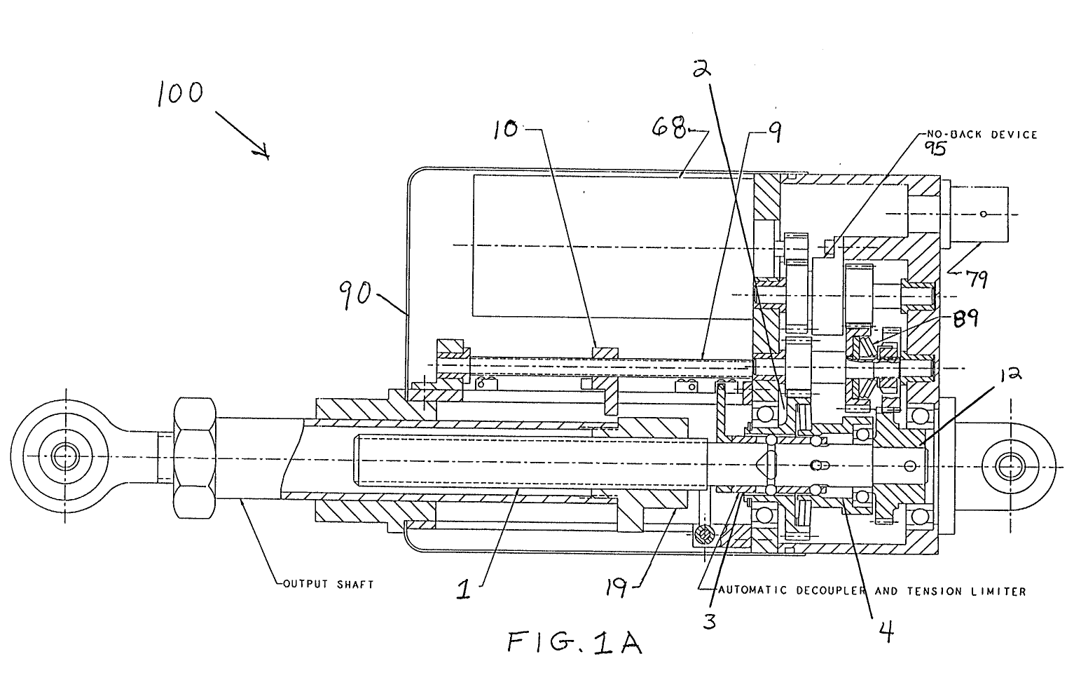

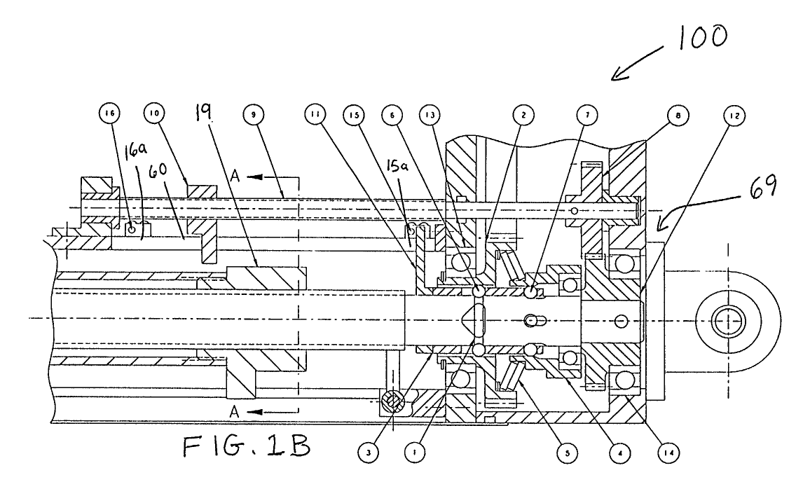

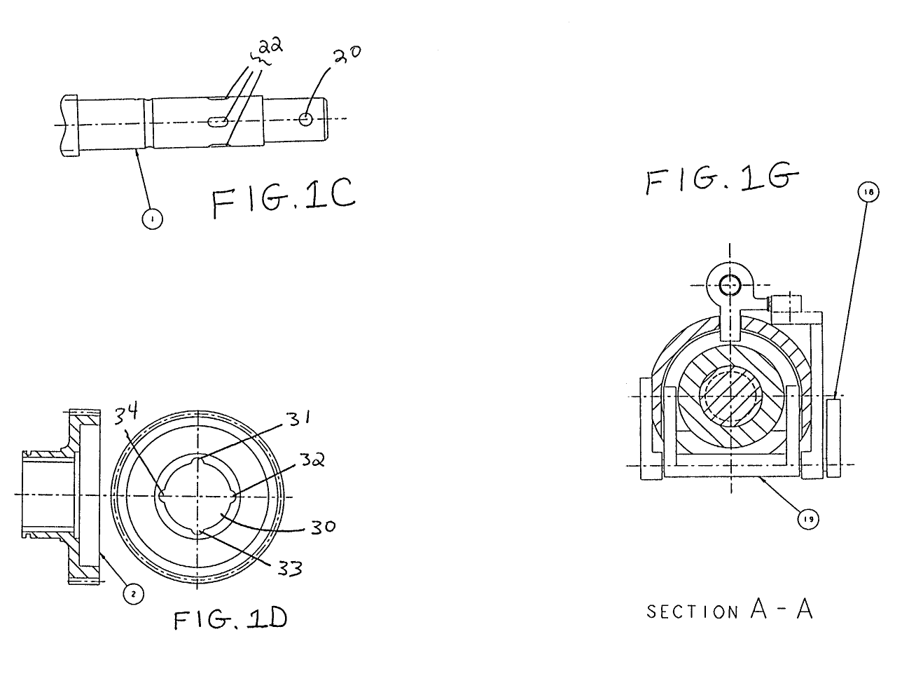

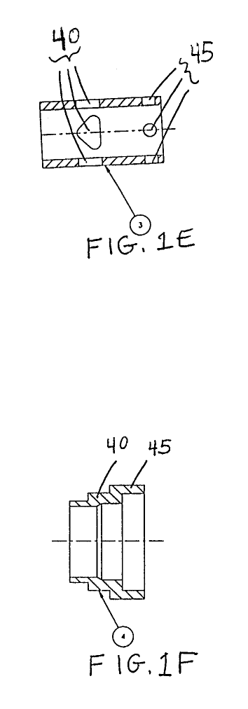

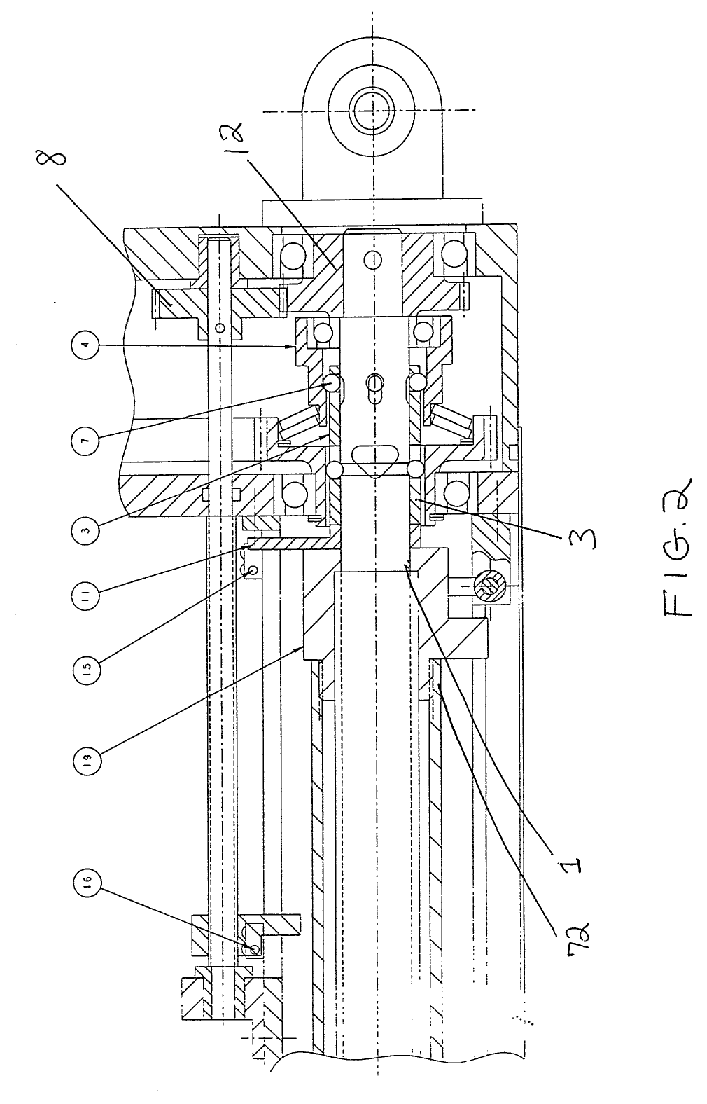

Referring now to FIGS. 1A-F, there is shown a linear actuator 100 having a disconnect mechanism and tension load limiter disposed in a housing 90 for limiting the tensile force on the shaft 1. The specific features of actuator 100 include shaft or ball screw rod 1 having one circular groove 20 and four axial grooves 22 on the exterior of the shaft as shown (the number of axial grooves depends on transmitted torque) in FIG. 1C. In referring to the drawings like reference numerals are used to indicate like parts. Output gear 2, as will described in more detail later operates to create an axial force in a given direction for moving sleeve 3 to cause engagement of the shaft 1 with gear 12. Output gear 2 includes four axial grooves 31, 32, 33, 34 on its internal diameter 30, as shown in FIG. ID (Top view). Sleeve 3 contains four triangular shaped slots 40 and four holes 45 as shown in FIG. 1E. Annular cup or collar 4 contains both a small 50 and a large 55 internal diameter bores, belleville springs 5 and adapter 11. In assembly as best shown in FIGS. 1A and 1B, there are two sets of moveable spheres or balls installed as follows: four balls 6 are disposed in the triangular slots 40 on the sleeve 3 trapped between the output gear 2 and the ball screw rod end 1, and another four balls 7 in the holes 45 on the sleeve within axial grooves 22 (FIG. 1C) on the ball screw rod 1 and one of the internal diameters of the cup 4. The ball screw rod end 1 carries a gear 12 in toothed engagement with idler gear 8 which rotates a threaded screw 9 and causes an axial movement of its nut 10 in a slot 60. This threaded nut operates two electrical limit switches 15 and 16 to control the stroke of the actuator. Torque limiter feature 89 comprising belleville springs in engagement with idler gear 8 operates to limit the torque lied to threaded screw 9. Ball screw rod 1 is coupled to electrically powered gear train gear 12 to cause rotation of the ball screw rod in direct response to movement of the gear. A shaft member mounted onto ball screw 12, such as nut 19, is translatable (i.e. axially moveable) between a retracted position and an extended position in response to rotation of ball screw 12. Note that rotatable screw 9 is positioned substantially parallel to the rotatable ball screw 1. Screw 9 is rotated by idler gear 8, which in turn is moved via gear 12. Moveable nut 10 is mounted on screw 9 such that rotation of the screw causes axial movement of nut 10 along the axis of screw 9.

The electrical limit switches 15 and 16 are adjusted to a position within the slot so as to be in alignment with the nut 10 so that the nut engages and activates the limit switch upon reaching the corresponding axial position (i.e. 16A or 15A) which causes the corresponding switch to terminate the connection between the electrical motor 68 and the gear train 10 including the gear 12 and idler gear 8. Electrical connector 79 coupled through housing 90 provides electrical connectivity from a standard power source to the motor and overall linear actuator unit in conventional fashion. As previously mentioned, rotatable screw 9 is in parallel alignment with and rotatable in concert with the rotatable ball screw 1. Accordingly, each of the correspondingly mounted nuts 10 and 19 translate on their respective parallel axes in concert and in proportion to one another. As one can ascertain, the direction of axial movement of the nut 10 is opposite the direction of axial movement of ball screw nut 19. Note that, as shown in FIGS. 1-3 and 5-7, threaded screws 1 and 9 are separated from one another within the housing by a sufficient distance so that nuts 10 and 19 do not engage one another during translation, but rather move freely along their axes over the course of the stroke.

When the actuator is commanded to extend in electrical operation as shown in FIG. 1B (via conventional means), the output gear 2 moves the balls 6 along the slopes of the triangular shaped slots 40 and creates an axial force which moves the sleeve 3 to the left and brings the balls 7 into the small internal diameter of the cup 4. At this point, the ball screw 1 is locked up with the gear train 12 and the actuator extends the output shaft such that movement of the gear causes rotation of the ball screw. Similarly, due to the triangular shape of the sleeving slots, the sleeve 3 shifts to the left and the ball screw engagement will occur when the actuator is commanded to retract.

FIG. 2 provides an illustration of the actuator 100 according to the present invention in a retracted position. Referring now to FIG. 2, when the actuator is fully retracted, the electric power from the motor to the gear train is disconnected by the limit switch 16 engaging nut 10. The ball screw nut 19 mounted on ball screw rod 1 and translatable between a first extended position and a second retracted position is moved in its slot 72 into the retracted position and forceably engages adapter 11. Adaptor 11 translates this force to sleeve 3, which moves to the right and disengages balls 7 by positioning them into larger internal diameter of the cup 4. Hence the ball screw 1 is disconnected from the gear train 12 and the actuator rod is now free to move and ready for manual operation.

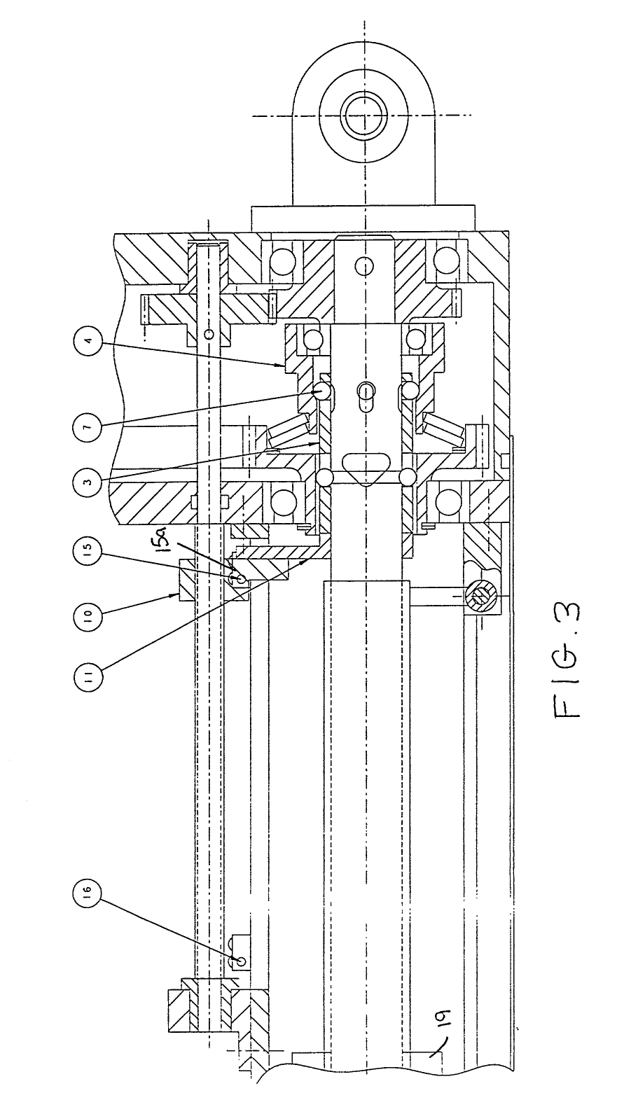

FIG. 3 represents an actuator 100 in a fully extended position. When the actuator is fully extended, the electric power is disconnected by the engagement of nut 10 with limit switch 15. The threaded auxiliary nut 10 is moved in its slot at axial position 15a and similarly shifts the sleeve 3 through adapter 11 to the right and disengages the balls 7 by positioning them into the larger internal diameter of the cup 4.

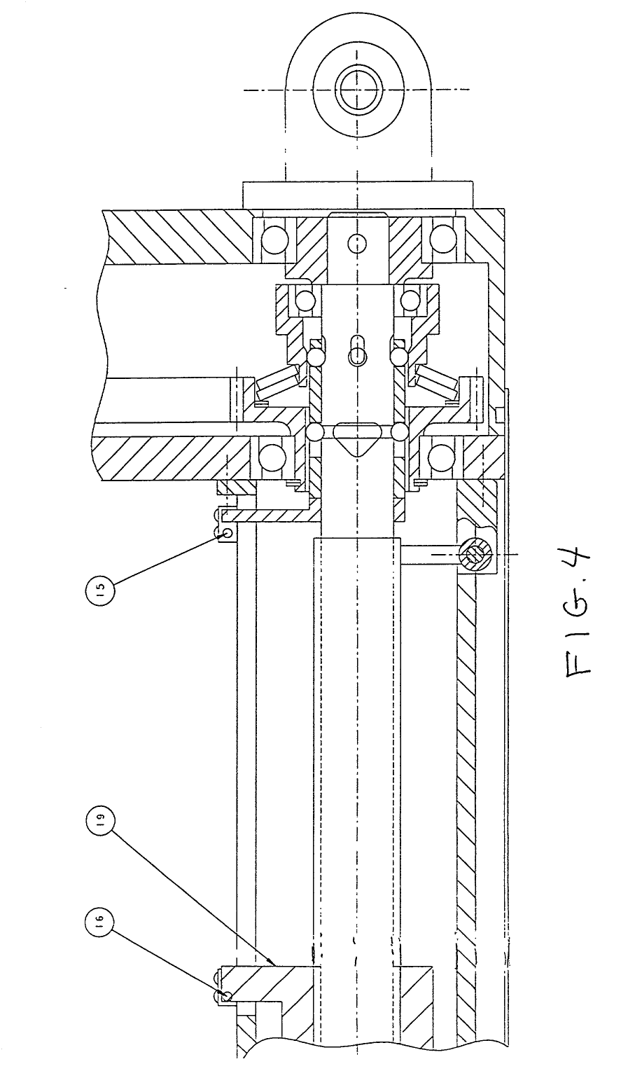

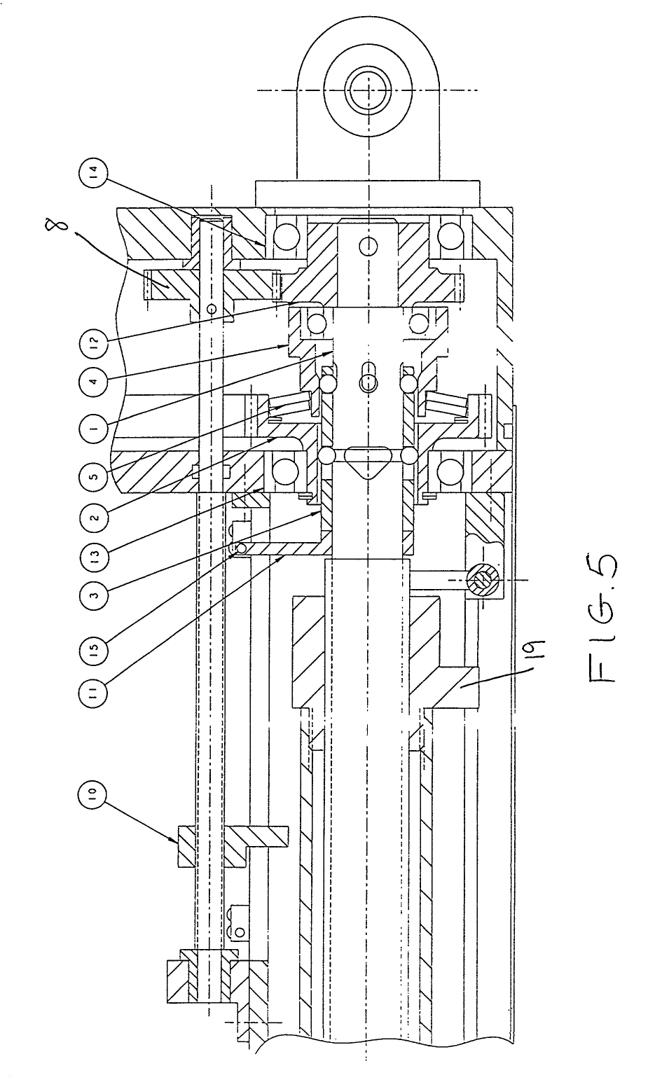

In an alternative embodiment shown in FIG. 4, the disconnection of the ball screw from the gear train in full extended position may be prevented by eliminating the idler gear 8, adapter 11 and the auxiliary screw 9 with its nut 10. In this case, the ball screw nut 19 directly operates electrical limit switches 15 and 16 to control the stroke of the actuator, as shown in FIG. 4.

Referring now to FIG. 5, the automatic disconnect mechanism incorporates two angular contact bearings 13 and 14, to take up the thrust loads right bearing-compression, left-tension. Under compression the thrust load is transmitted directly to the right bearing 14 and gear 12. During an operation under tension load, the ball screw 1 with cup 4 by squeezing the spring 5 and together with sleeve 3 shifts to the left and then the load through output gear 2 is transmitted to the left bearing 13. When the tension load reaches a preset limit, the shifted sleeve 3 through adapter 11 presses the limit switch 15 which disconnects the electrical motor. The same switch operates to disconnect the electrical motor at the end of the travel by the moving auxiliary nut 10. This way, the tension load could be limited during retraction and along the entire stroke of the actuator.

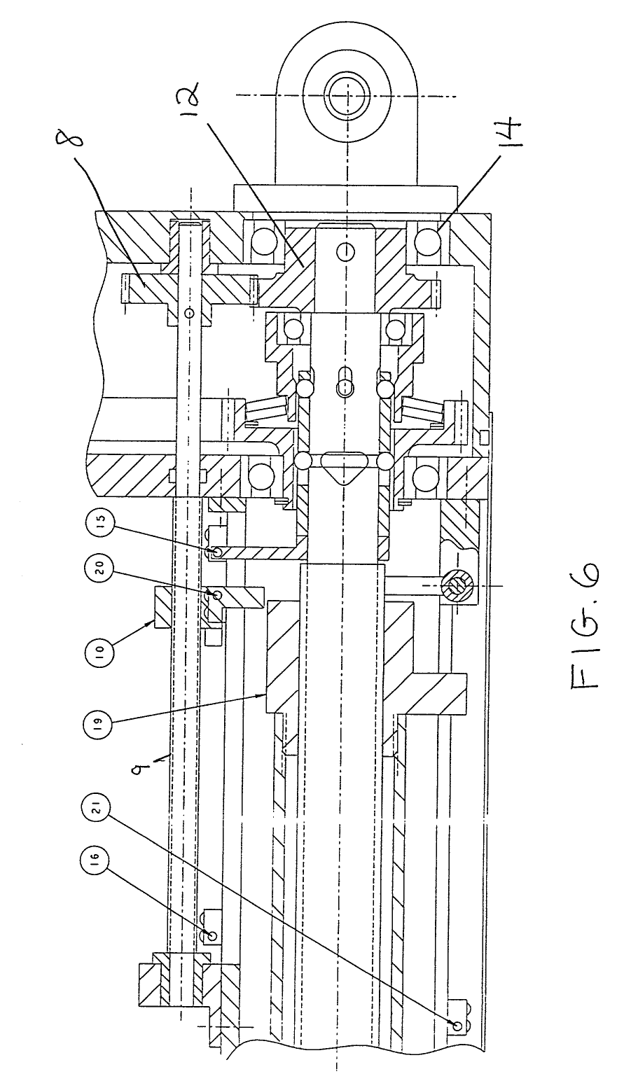

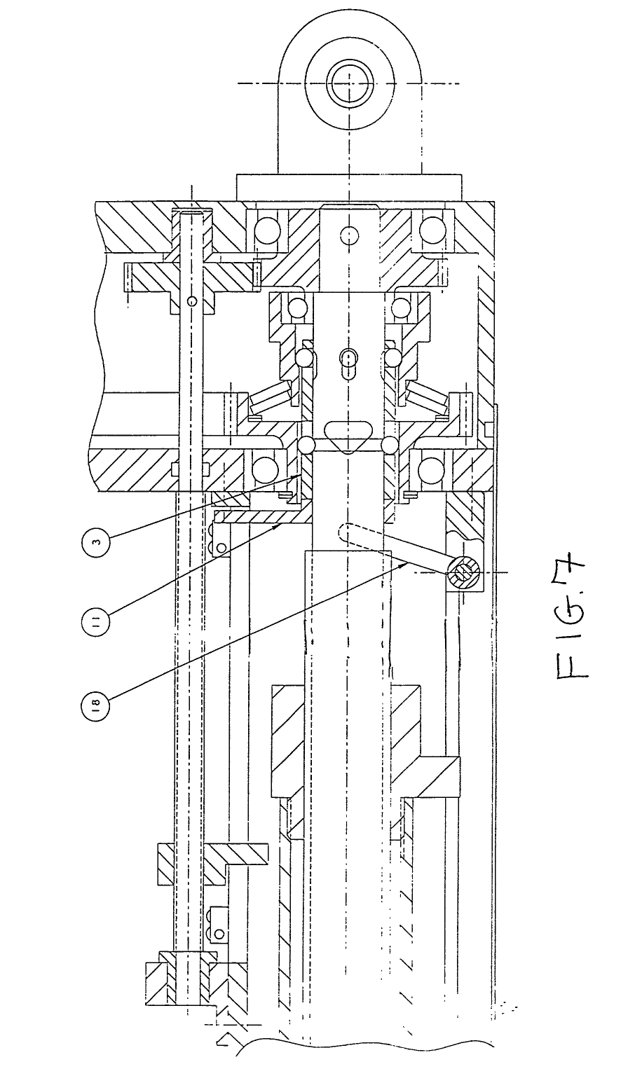

To limit the tension load at a specified location, as illustrated in FIG. 6, two limit switches may be pressed simultaneously: switch 15, by the sleeve 3, and the additional switch 20, installed at a specified location, by the moving auxiliary nut 10. If these two switches are located close to one another, then the width of the auxiliary nut should be designed to enable depression of both of them at the end of the stroke. If the required location is far from the end of the travel, or for other design considerations, an independent travel limit switch 21, could be used which would be operated by the moving ball screw nut 19 at the end of the stroke.

The proposed design provides for an external handle (shown in FIG. 1B Section A-A) to permit, if necessary, manual operation (opening or closing) when the actuator is partially extended. As shown in FIG. 7, by turning the handle to the right, the lever 18 pushes the sleeve 3 through adapter 11 and disconnects the ball screw from gear train and allows manual operation.

It should be understood that the embodiments described herein are merely exemplary, and that a person skilled in the art may make variations and modifications without departing from the spirit and scope of the invention. All such variations and modifications are intended to be within the scope of the invention as defined in the appended claims.

What is claimed is:

1. A linear actuator for generating linear movement of a shaft member comprising:
an electrically powered gear train coupled to a shaft assembly disposed in a housing and including a rotatable member on which is mounted said shaft member for causing axial movement of said shaft member along an axis of said shaft assembly between a first extended position and a second retracted position;
means responsive to the movement of said gear train for causing axial movement of a second member in proportion to the axial movement of said shaft member;
disconnect means responsive to the axial position of said axially movable second member for automatically disconnecting power to said gear train when said second member reaches an at least one predetermined axial position to prohibit further axial movement of said shaft member; and
decouple means for automatically decoupling the shaft assembly from the gear train according to an at least one given axial position associated with said shaft member or second member.

2. The linear actuator according to claim 1, further comprising load limiting means mounted on said shaft assembly and responsive to a predetermined tension or compression force exerted on said actuator for automatically disconnecting power to said gear train when said tension or compression force exceeds a predetermined threshold, thereby prohibiting further movement of said shaft member.

3. The linear actuator according to claim 1, wherein said disconnect means includes a switch coupled to said housing and in alignment with said axially movable second member at said predetermined position and operative to disconnect power between a power source and said gear train when said axially movable second member engages said switch.

4. The linear actuator according to claim 1, wherein the direction of movement of said shaft member is opposite the direction of movement of said second axially movable member.

5. The linear actuator according to claim 4, wherein said at least one predetermined position comprises said first extended position and said second retracted position.

6. The linear actuator according to claim 5, wherein said disconnect means includes first and second switches coupled to said housing, each operative to terminate connectivity between said gear train and a power source upon activation, said first switch in alignment with said axially moveable second member at said first extended position and said second switch in alignment with said axially moveable second member at said second retracted position, whereby said axially movable second member engages said first or second switch upon reaching said corresponding first extend or second retracted position, thereby activating said corresponding first or second switch and terminating power to said gear train.

7. The linear actuator according to claim 1, wherein said gear train includes a first gear for rotating said rotatable member, and a second gear in toothed engagement with said first gear; and
wherein said means for causing axial movement of said movable second member comprises:
a rotatable screw positioned substantially parallel to said rotatable member and rotatable by said second gear, said moveable second member mounted on said rotatable screw such that rotation of said screw causes axial movement of said moveable second member along an axis of said screw.

8. The linear actuator according to claim 1, wherein said axially movable member comprises an axially movable internally threaded nut mounted on said rotatable threaded screw, said rotatable screw rotatable in concert with said shaft assembly rotatable member such that rotation of said screw causes axial movement of said nut along an axis of said screw in a direction opposite the direction of axial movement of said shaft member.

9. The linear actuator according to claim 1, wherein said decoupling means for decoupling the shaft assembly from the gear train comprises:
an annular collar surrounding a portion of said rotatable member and coupled to said gear train, said collar having a first interior diameter bore and a second larger interior diameter bore;
bearing means movable within said collar between said first interior diameter and said second interior diameter bores for frictionally engaging axial grooves formed on said rotatable member to cause engagement of said gear train with said rotatable member when said bearing means is within said first diameter bore, and when said bearing means is displaced into said second larger diameter, for causing disengagement with said axial frictional grooves on said rotatable member to permit movement of either one of said shaft assembly or said gear train without corresponding movement of the other one; and
an axially movable sleeve member mounted on said rotatable member and responsive to a force resulting from said axially movable second member or said shaft member when either said second member or said shaft member is located at said given axial position for moving a predetermined distance in a first direction to displace said bearing means into said larger diameter interior surface of said collar, thereby causing decoupling of the shaft assembly from the gear train.

10. The linear actuator according to claim 9, further comprising an adapter positioned between said moveable second member or said shaft member, and said axially moveable sleeve, wherein said adapter operates to axially move said sleeve in said first direction away from said shaft member when either said shaft member or said axially moveable second member reach said given axial position corresponding to the retracted position.

11. The linear actuator according to claim 2, wherein said load limiter means includes:
first and second contact bearing means mounted at predetermined positions along said shaft assembly and said gear train for receiving an axial force directed from said gear train;
spring means responsive to the axial force received by said first and second contact bearing means for opposing said axial force; and wherein
an axially movable sleeve mounted on said rotatable member is axially moveable when said axial force exceeds the opposing force of said spring means such that movement of said sleeve a predetermined distance indicative of said predetermined force threshold causes activation of a switch for terminating power to said gear train.

12. A linear actuator for providing linear motion of an output shaft member and an automatically disconnecting said shaft from a gear train comprising:
a rotatable shaft adapted to be coupled to an electrically powered gear train for causing rotation of said shaft;
a shaft member mounted onto said rotatable shaft and axially moveable between a retracted position and an extended position in response to rotation of said shaft;
a rotatable screw co-acting with said gear train to rotate in response to movement of said gear train;
a second member mounted on said rotatable screw and axially movable in response to rotation of said screw between said retracted position and said extended position;
switch means located at at least one of said extended and retracted positions and responsive to engagement with said movable second member for causing an electrical disconnection between said gear train and a power source to cause termination of shaft rotation; and
means coupled to said rotatable shaft for disconnecting said shaft from said gear train in response to said shaft member or second member reaching said retracted position.

13. The linear actuator according to claim 12, wherein said rotatable screw is in parallel alignment with and rotatable in concert with said rotatable shaft.

14. The linear actuator according to claim 13, wherein said axially moveable second member moves in concert with said shaft member and in a direction opposite that of said shaft member.

15. The linear actuator according to claim 12, wherein said switch means comprises a first switch adjustably mounted in a slot on said housing and engageable with said moveable second member when said member reaches a position corresponding to said extended position, and a second switch adjustably mounted in a slot on said housing and engageable with said moveable first member when said member reaches a position corresponding to said retracted position, wherein said first and second switches operate to disconnect power between said gear train and a motor upon engagement with said moveable second member.

16. The linear actuator according to claim 12, further comprising load limiting means coupled to said rotatable shaft and responsive to a tension force exerted on said rotatable shaft for automatically disconnecting power to said gear train when said tension force exceeds a predetermined threshold.

17. The linear actuator according to claim 12, further comprising manual means mounted on said rotatable shaft and responsive to a manual force for causing said gear train to disengage from said rotatable shaft to allow manual operation of said actuator.

18. The linear actuator according to claim 16, wherein said load limiting means comprises means for limiting the tension load at a specific location along said rotatable screw axis between said retracted position and said extended position.

19. A linear actuator for providing linear motion of a shaft member comprising:
a rotatable shaft on which said shaft member is mounted, the shaft adapted to be coupled to an electrically powered gear such that rotation of said gear causes rotation of said shaft and corresponding translation of said shaft member between a first extended position and a second retracted position along an axis of said shaft;
disconnect means responsive to the position of said axially moving shaft member for automatically disconnecting power to said gear train when said shaft member reaches an at least one predetermined position along said axis; and
decouple means for automatically decoupling said shaft from said gear when said shaft member reaches a given position along said axis.

20. The linear actuator according to claim 19, wherein said disconnect means automatically disconnects power to said gear train when said shaft member reaches either said first extended position or said second retracted position along said axis.

21. The linear actuator according to claim 19, wherein said given position of said shaft member for automatically decoupling said rotatable shaft from said gear corresponds to said retracted position.

22. A linear actuator for generating linear movement of a shaft member comprising:
a gear train coupled to a shaft assembly disposed in a housing and including a rotatable member on which is mounted said shaft member for causing axial movement of said shaft member along an axis of said shaft assembly between a first extended position and a second retracted position;
means responsive to the movement of said gear train for causing axial movement of a second member between an initial position which corresponds to said shaft member at said extended position and a final position which corresponds to said shaft member at said retracted position so that said axial movement of said second member is in proportion to the axial movement of said shaft member; and
decouple means mounted on said shaft assembly and responsive to the position of said second member or of said shaft member for automatically decoupling the shaft assembly from the gear train when said shaft member reaches said retracted position or said second member reaches said initial position.

23. The linear actuator according to claim 22, wherein said gear train is electrically powered, said linear actuator further comprising load limiting means mounted on said shaft assembly and responsive to a predetermined tension or compression force exerted on said actuator for automatically disconnecting power to said gear train when said tension or compression force exceeds a predetermined threshold, thereby prohibiting further movement of said shaft member.

24. The linear actuator according to claim 22, wherein the direction of axial movement of said shaft member is opposite the direction of axial movement of said axially movable second member.
